(19) United States
(12) Patent Application Publication
(10) Pub. No.: US 2018/0085694 A1
(43) Pub. Date: Mar. 29, 2018

(54) FLUE GAS TREATMENT APPARATUS

(71) Applicant: MITSUBISHI HITACHI POWER SYSTEMS, LTD., Yokohama-shi, Kanagawa (JP)

(72) Inventors: Noriyuki Imada, Yokohama-shi (JP); Masaaki Ishioka, Yokohama-shi (JP); Akihiro Yamada, Yokohama-shi (JP); Goki Sasaki, Yokohama-shi (JP); Katsumi Yano, Yokohama-shi (JP); Keigo Uchiyama, Yokohama-shi (JP)

(73) Assignee: MITSUBISHI HITACHI POWER SYSTEMS, LTD., Yokohama-shi, Kanagawa (JP)

(21) Appl. No.: 15/562,271

(22) PCT Filed: Apr. 7, 2016
(86) PCT No.: PCT/JP2016/061375

§ 371 Date: Sep. 27, 2017

(30) Foreign Application Priority Data
Apr. 8, 2015 (JP) 2015-079210

(51) Int. Cl. B01D 45/08; B01D 53/86

(52) U.S. Cl. CPC B01D 45/08; B01D 53/8625

(57) ABSTRACT

The disclosure relates to suppressing wear of a denitration catalyst due to ash particles having diameters greater than or equal to 100 μm. A flue gas treatment apparatus includes a denitration apparatus having a denitration catalyst, which reduces nitrogen oxides in flue gas exhausted from the coal combustion boiler, and a duct that guides the flue gas from the coal combustion boiler to the denitration apparatus, and the duct is formed of a horizontal duct connected to a flue gas outlet of the coal combustion boiler, a vertical duct connected to the horizontal duct, and a hopper provided below a portion where the horizontal duct and the vertical duct are connected to each other, wherein a collision plate, which causes ash particles in the flue gas to collide with the collision plate and fall into the hopper, is provided in an upper-end opening section of the hopper.

### TECHNICAL FIELD

The present invention relates to a flue gas treatment apparatus, and particularly to a flue gas treatment apparatus including a denitration apparatus that reduces nitrogen oxides contained in flue gas from a boiler (for electric power generation, for example) using coal as the fuel and removes the resultant products.

### BACKGROUND ART

For example, to remove nitrogen oxides (NOx) in combustion flue gas from a coal combustion boiler for electric power generation, a denitration apparatus that injects a reducing agent (ammonia, for example) into the flue gas to reduce NOx into N₂ with a denitration catalyst is typically used. The denitration apparatus is configured to guide flue gas exhausted from a heat exchanger, such as a super heater and an economizer (coal economizer) of a boiler using coal as the fuel, to a top portion of the denitration apparatus via a horizontal duct and a vertical duct, as described, for example, in Patent Literature 1. The denitration apparatus has a denitration catalyst that reduces nitrogen oxides, and a reducing agent is injected into the flue gas through nozzles provided in a vertical duct on the upstream side of the denitration catalyst or a duct on the side facing the inlet of the denitration apparatus. The denitration catalyst is typically formed by laminating a plurality of catalysts each formed in a plate-like shape or a honeycomb-like shape on each other to form a laminar structure, and the resultant catalyst layer typically has apertures each having a size ranging from about 5 to 6 mm.

On the other hand, a coal combustion boiler burns coal crashed with a mill into minute coal particles having an average diameter smaller than or equal to 100 μm, supplied into a furnace, and combusted. Dust or ash (hereinafter collectively referred to as ash particles) produced by the combustion typically has a size smaller than or equal to several tens of microns. When slag and clinker having adhered to the heat transfer tube and the sidewall of the boiler is blown, for example, with a soot blower, however, ash masses having sizes ranging from about 5 to 10 mm are produced, travel along with the flue gas to the denitration apparatus, and cause deposits to build up on the catalyst layer. When the ash masses deposit on the surface of the catalyst, the ash mass deposit undesirably blocks the flue gas flow and therefore prevents the denitration reaction.

To solve the inconvenience produced by the ash masses, there is a proposal to provide a hopper below the connecting portion where the horizontal duct and the vertical duct are connected to each other and collect the ash masses in the hopper, as described in Patent Literatures 1 or 2. There is another proposal to slow the flue gas flowing through the duct that guides the flue gas from the boiler to the denitration apparatus and collect the ash masses with a wire-cloth screen disposed in the horizontal or vertical duct. There is still another proposal to dispose a louver formed of a plurality of plate-shaped members in an inner wall portion of the vertical duct or dispose an obstruction plate to collect the ash masses and cause the ash masses to fall into a hopper below the vertical duct.

Patent Literature 3 proposes to dispose a plate member that deflects the flue gas flow downward on the upstream side in the horizontal duct to deflect the ash particles toward the bottom wall of the horizontal duct and collect the ash particles in a hopper. Patent Literature 3 further proposes to provide a collection plate in such a way that it extends from the bottom wall of the horizontal duct to a point above the hopper and use swirls produced when the flue gas flows around the collection plate to collect the ash particles in the hopper. Patent Literature 3 still further proposes to provide a horizontal deflection plate in the portion where the hopper with which the flue gas flowing through the horizontal duct collides is connected to the vertical duct in such a way that the deflection plate overhangs to a point above the hopper and allow the deflection plate to guide the flow of the gas flowing into the hopper to the lower surface of the collection plate described above to enhance the ash particle collection effect.

### CITATION LIST

### Patent Literature

Patent Literature 1: JP-A-2-95415

Patent Literature 2: JP-A-8-117559

Patent Literature 3: U.S. Pat. No. 7,556,674B2

### SUMMARY OF INVENTION

### Technical Problem

In Patent Literatures described above, however, no consideration is given to a case where the ash particles include those having diameters ranging from 100 to 300 μm. That is, in China, India, and other countries, they plan to introduce coal combustion boilers using not only high-quality coal produced in Australia but coal having a large amount of ash that makes it difficult to crush the coal into minute particles. For example, results of measurement of technical analysis values of coal produced in an Inner Mongolia district of China (coal A) and the distribution of the diameter of ash particles contained in flue gas show that the proportion of ash in the coal A is as high as 47% as compared with the proportion of ash in coal produced in Australia (coal B), which is about 13%. As for the ash particle-size distribution, 99% of the coal-B particles have diameters smaller than or equal to 100 μm, whereas the proportion of coal-A particles having diameters smaller than or equal to 100 μm is merely about 50%. That is, in the case of coal A, half the ash is formed of particles having diameters greater than or equal to 100 μm.

As described above, it has been shown that a situation in which the flue gas contains ash that accounts for 30-40% or higher or a situation in which the flue gas contains ash particles having large diameters greater than or equal to 100 μm causes a new problem of wear of a denitration catalyst in a short period. For example, the wire-cloth screen proposed in some of Patent Literatures can remove ash masses having sizes ranging from about 5 to 10 mm, which are larger than the openings of the catalyst layer, but cannot remove ash masses having sizes ranging from 100 μm to 5 mm, which are smaller than the sizes described above.

On the other hand, when the size of the openings of the wire-cloth screen is set, for example, at 100 μm, not only does pressure loss in the duct undesirably increase, but the frequency of occurrence of screen clogging undesirably increases. Further, since ash particles having diameters ranging from 100 to 300 μm accompany flue gas flowing at a flow rate of several meters/second, the louver formed of a plurality of plate-shaped members disposed in the inner wall of the duct cannot solve the problem of the wear of the denitration catalyst because the ash having collided with the louver accompanies the flue gas flow again and is blown toward the downstream side.

An object to be solved by the present invention is to provide a flue gas treatment apparatus capable of suppressing wear of a denitration catalyst due to ash particles having diameters greater than or equal to 100 μm.

### Solution to Problem

The inventors of the present invention have used a numerical analysis approach to intensively conduct a study on the path of ash particles that accompany flue gas guided from a boiler outlet via a horizontal duct and a vertical duct to a denitration apparatus and have found that ash particles having a diameter of 30 μm roughly uniformly disperse in the ducts and reach the denitration apparatus, whereas ash particles having a diameter of 200 μm are locally present in a lower portion of the horizontal duct and accompany the flue gas, as will be described later.

The present invention relates to a flue gas treatment apparatus including a denitration apparatus having a denitration catalyst that reduces nitrogen oxides in flue gas exhausted from a coal combustion boiler, and a duct that guides the flue gas from the coal combustion boiler to the denitration apparatus, the duct being formed of a horizontal duct connected to a flue gas outlet of the coal combustion boiler, a vertical duct connected to the horizontal duct, and a hopper provided below a connecting portion where the horizontal duct and the vertical duct are connected to each other, and as a first characteristic of the present invention, a collision plate that causes ash particles in the flue gas to collide with the collision plate and fall into the hopper is provided in an upper-end opening section of the hopper.

According to the present invention having the first characteristic, providing the collision plate, which causes the ash particles in the flue gas to collide with the collision plate and fall into the hopper, in the upper-end opening section of the hopper, that is, in an extension plane of the bottom wall of the horizontal duct allows ash particles having diameters greater than or equal to 100 μm that are locally present in a lower portion of the horizontal duct and accompany the flue gas to collide with the collision plate for selective collection of the ash particles in the hopper. As a result, the particles having diameters greater than or equal to 100 μm can be collected in the hopper with high efficiency, whereby a situation in which the large-diameter ash particles wear a denitration catalyst can be avoided.

In this case, the collision plate is preferably formed in a rectangular shape and disposed such that a lower long edge of the collision plate is located in an upper-end opening plane of the hopper corresponding to an extension plane of a bottom wall of the horizontal duct and the lower long edge extends in a width direction of the horizontal duct. The thus configured collision plate allows ash particles having diameters greater than or equal to 100 μm that are locally present in a lower portion of the horizontal duct and accompany the flue gas to effectively collide with the collision plate and fall into the hopper. Since the collision plate only needs to have a rectangular shape having short edges corresponding to the region where the ash particles having diameters of greater than or equal to 100 μm are locally present on the side facing the bottom wall of the horizontal duct and scatter, whereby loss of the pressure of the flue gas flow can be suppressed to a small value.

The collision plate may be provided in a range that is measured from a far-side end of the upper-end opening of the hopper viewed from a side facing the horizontal duct and corresponds to one-fourth to three-fourths of a length of the upper-end opening. Further, the collision plate is preferably provided so as to incline toward the horizontal duct by a set angle “a” (0°<a≦90°) with respect to an upper-end opening plane of the hopper.

As a second characteristic of the present invention, a partition plate is further provided in the hopper so as to be perpendicular to an extension of the horizontal duct and to extend downward in a vertical direction.

According to the second characteristic, the partition plate can suppress (reduce) the flue gas that flows through the horizontal duct, collides with the wall surface of the hopper, travels along the sidewall of the hopper toward the bottom thereof, turns around at the bottom where collected ash particles deposit, and travels upward. As a result, a situation in which the ash particles collected in the hopper scatter again can be avoided, whereby the number of particles having diameters greater than or equal to 100 μm that reach the denitration catalyst can be suppressed. In this case, the partition plate is preferably provided in a position that is measured from a far-side end of the upper-end opening of the hopper viewed from a side facing the horizontal duct and corresponds to half a length of the upper-end opening, that is, a central position of the upper-end opening.

The present invention is characterized in that the flue gas outlet, to which the horizontal duct is connected, is formed in a sidewall of a downward flue gas channel in which a heat recovery/heat transfer tube of the coal combustion boiler is disposed, and that an overhang section is provided in the flue gas channel so as to overhang from the sidewall of the flue gas channel above the horizontal duct at the flue gas outlet.

### Advantageous Effects of Invention

The present invention allows suppression of wear of a denitration catalyst due to ash particles having diameters greater than or equal to 100 μm.

### BRIEF DESCRIPTION OF DRAWINGS

FIG. 1 is an overall configuration diagram of a first embodiment of a flue gas treatment apparatus according to the present invention.

FIG. 2 FIGS. 2(a) and 2(b) are an enlarged perspective view and a cross-sectional view of hoppers that characterize the first embodiment.

FIG. 3 is a perspective view of an example of a denitration catalyst in the first embodiment.

FIG. 4 shows an example of the ash particle diameter distribution showing the difference in coal type.

FIG. 5 shows results of technical analysis values of the two types of coal and results of ash composition analysis.

FIG. 6(a) shows a numerical analysis of a scatter path of ash particles from a boiler outlet via a horizontal duct and a vertical duct to a desulfurization device, and FIG. 6(b) shows the numerical analysis of the scatter path of ash particles having a different size.

FIG. 7 shows a result of analysis of the gas flow rate distribution in a case where a collision plate in the first embodiment is disposed.

FIG. 8 shows a result of analysis of the path of large-diameter ash particles in the case where the collision plate in the first embodiment is disposed.

FIG. 9 shows a result of analysis of the gas flow rate distribution in a case where re-scatter preventing plates in the first embodiment are disposed.

FIG. 10 shows results of examination of the position of the collision plate in the first embodiment.

FIG. 11 shows results of examination of the shape of the re-scatter preventing plates in the first embodiment.

FIG. 12 shows differences in ash particle collection percentage among several shapes of the re-scatter preventing plates.

FIG. 13 shows proportions of scattering particles having diameters of 100, 200, and 360 μm in the first embodiment as compared with related art.

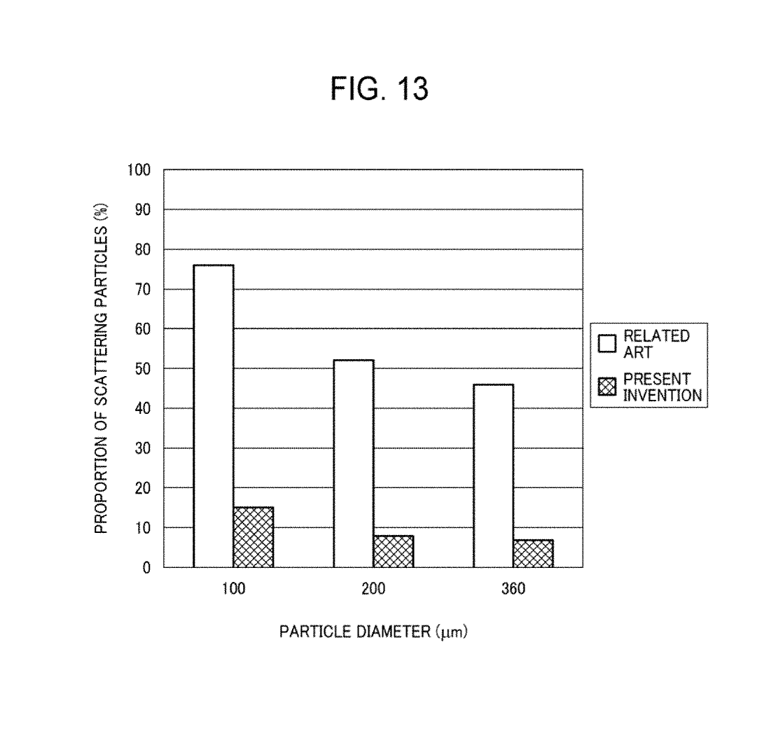

FIG. 14 describes a variation in which an overhang section is provided at the boiler outlet to which the horizontal duct is connected in the first embodiment.

FIG. 15 shows a difference in the ash particle collection percentage between presence and absence of the overhang section in FIG. 13.

FIG. 16 is a configuration diagram of key parts in a second embodiment of the flue gas treatment apparatus according to the present invention.

FIG. 17 shows results of calculation of the ash particle collection percentage versus an angle α of sidewall collision plates in the second embodiment.

FIG. 18 shows results of calculation of the ash particle collection percentage versus an angle β of the sidewall collision plates in the second embodiment.

FIG. 19 shows results of calculation of the ash particle collection percentage versus a width d of the sidewall collision plates in the second embodiment.

FIG. 20 shows results of calculation of the ash particle collection percentage versus a distance L1 between the lower ends of the sidewall collision plates in the second embodiment and upper portions of the hoppers.

FIG. 21 shows details of a ceiling collision plate in a third embodiment.

### DESCRIPTION OF EMBODIMENTS

A flue gas treatment apparatus according to the present invention will be described below on the basis of embodiments.

### First Embodiment

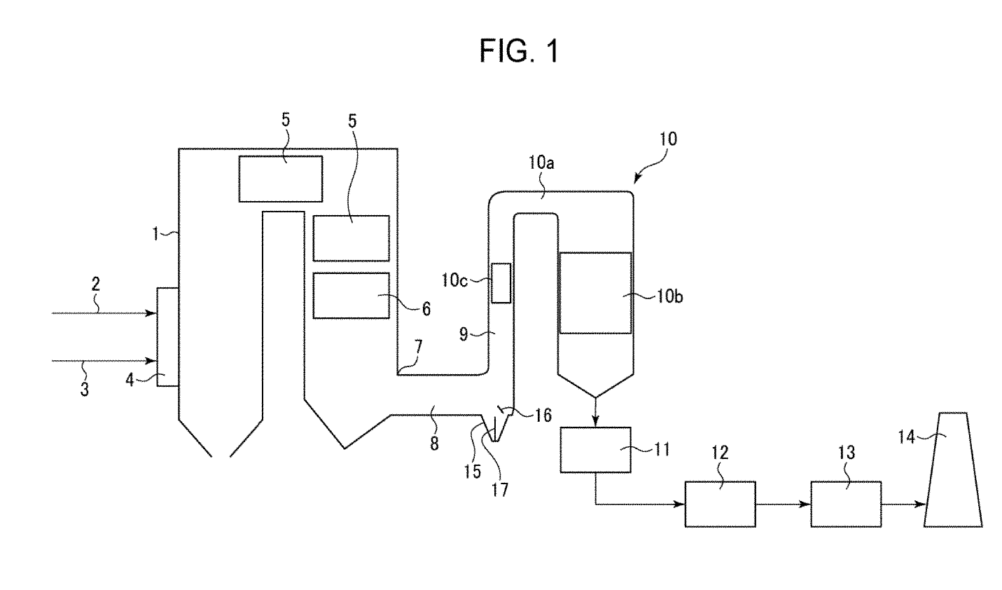

The overall configuration of a first embodiment of the flue gas treatment apparatus according to the present invention will be described with reference to FIG. 1. A coal combustion boiler 1 includes a burner 4, which uses combustion gas 3 to combust coal 2 crushed by a crusher that is not shown, such as a mill. The coal combustion boiler 1 further includes a plurality of heat recovery/heat transfer tubes 5, through which water flows, in a furnace and a flue gas channel of the coal combustion boiler 1, and an economizer (coal economizer) 6, which is one of the heat recovery/heat transfer tubes 5, is further provided in a downstream portion of the flue gas channel of the coal combustion boiler 1. The coal combustion boiler 1 is thus configured to produce steam that drives an electrical power generating turbine that is not shown.

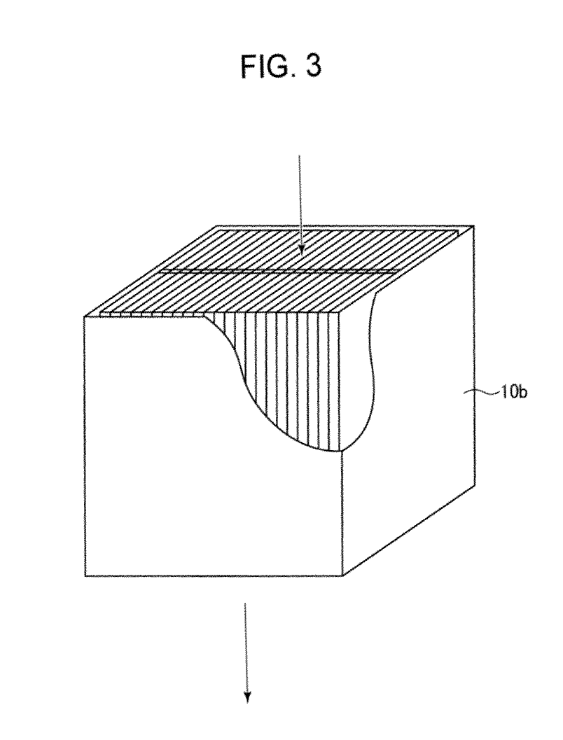

A flue gas outlet 7 of the coal combustion boiler 1 is provided through a boiler sidewall below the economizer 6, and a horizontal duct 8 is connected to the flue gas outlet 7. The other end of the horizontal duct 8 is connected to the sidewall of a vertical duct 9, and the upper end of the vertical duct 9 is connected to an inlet duct 10a of a denitration apparatus 10. Flue gas produced when the coal combustion boiler 1 combusts the coal is guided through the flue gas outlet 7 via the horizontal duct 8 and the vertical duct 9 to a top portion of the denitration apparatus 10. The denitration apparatus 10 is so configured that the interior thereof is be filled with a denitration catalyst 10b, which is shown in FIG. 3, and ammonia is injected as a reducing agent through an ammonia supply nozzle 10c, which is provided at some midpoint of the vertical duct 9. The denitration apparatus 10 is thus configured to reduce nitrogen oxides (NOx) contained in the flue gas and exhaust the resultant products. The flue gas from which NOx has been removed and which is exhausted from the denitration apparatus 10 travels through an air heater 11, which heats the burned gas, a dust collector 12, and a desulfurization device 13 and is discharged out of a chimney 14 into the air.

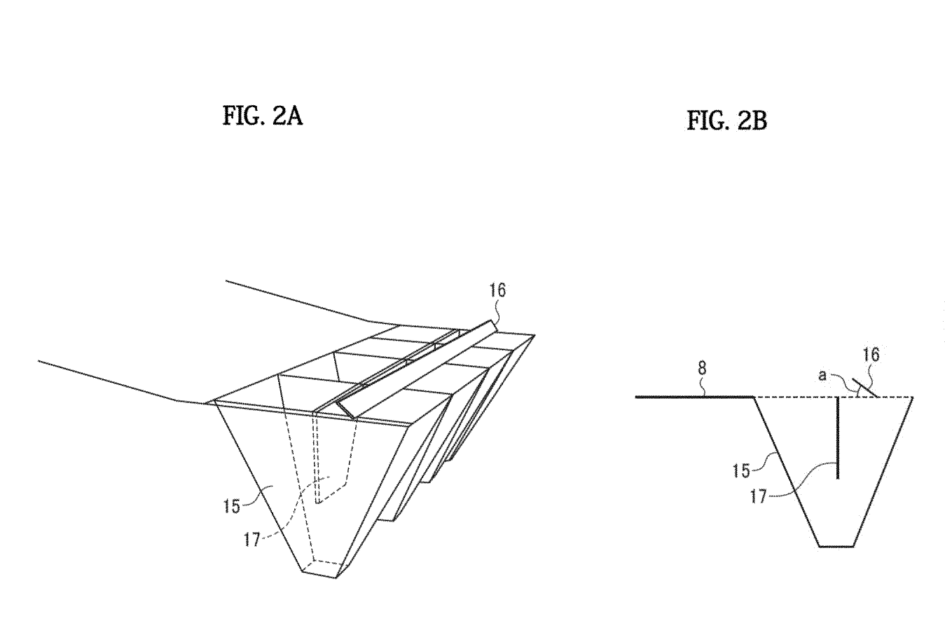

The configuration of a characteristic portion of the present invention will next be described. A plurality of hoppers 15 are disposed below the vertical duct 9, which is connected to the end of the horizontal duct 8, along the width direction of the horizontal duct 8, as shown in FIGS. 1 and 2. The upper-end opening plane of each of the hoppers 15 is disposed so as to agree with the position of the bottom wall surface of the horizontal duct 8. A collision plate 16 is provided so as to be located along the upper-end opening planes of the hoppers 15 and cause ash particles in the flue gas to collide with the collision plate 16 and fall into the hoppers 15. The collision plate 16 in the present embodiment is formed in a rectangular shape and disposed such that the lower long edge of the collision plate 16 is located in the upper-end opening planes of the hoppers corresponding to an extension plane of the bottom wall of the horizontal duct 8 and the lower long edge extends in the width direction of the horizontal duct 8, as shown in FIG. 2(a). The width of the short edges of the collision plate 16 is determined in accordance with the thickness of the flow of large-diameter ash particles, which scatter along the bottom wall of the horizontal duct 8, as described below. For example, the width of the short edges of the collision plate 16 can be selected from values within a range from 2 to 7% of the vertical width H of the horizontal duct 8 and is determined in consideration of the relationship between loss of the pressure of the flue gas flow and an ash particle collection percentage. Further, the collision plate 16 is provided so as to incline toward the horizontal duct 8 with respect to the upper-end opening planes of the hoppers 15, as shown in FIG. 2(b). The inclination angle “a” can be any value within the range 0°<a≦90° to cause the ash particles to collide with the collision plate 16 and effectively fall into the hoppers 15.

A re-scatter preventing partition plate 17 is disposed in each of the hoppers 15. That is, the partition plate 17 is provided in each of the hoppers 15 so as to be perpendicular to an extension of the horizontal duct 8 and extend downward in the vertical direction. The thus disposed partition plates 17 can suppress (reduce) the flue gas that flows through the horizontal duct 8, collides with the wall surfaces of the vertical duct 9 and the hoppers 15, travels along the sidewalls of the hoppers 15 toward the bottoms thereof, turns around at the bottoms where the collected ash particles deposit, and travels upward, whereby a situation in which the collected ash particles scatter again can be avoided.

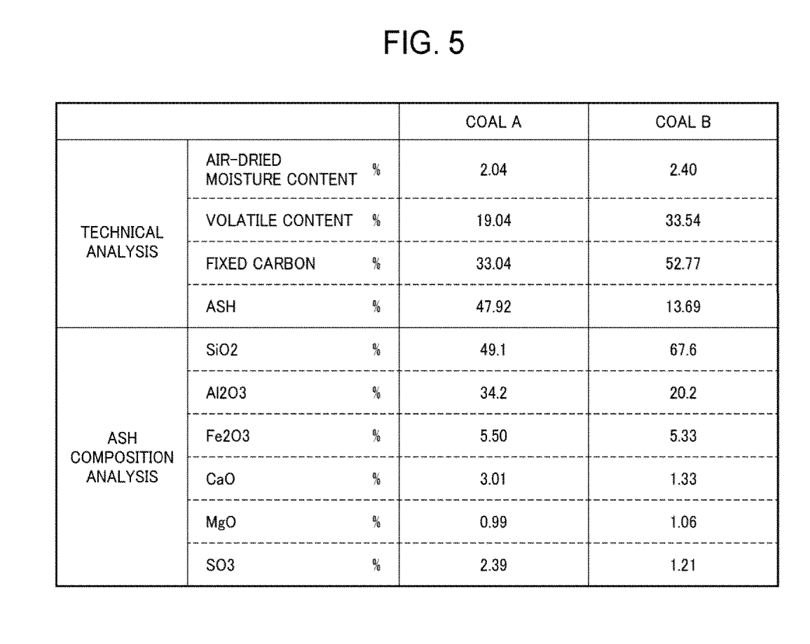

With reference to the thus configured first embodiment of the present invention, the action of the coal combustion boiler 1 will be described with reference to a case where the coal combustion boiler 1 is operated by using the coal A, which is low-quality coal as shown in FIG. 5. The coal combustion boiler 1, in which the coal 2 and air as the combustion gas 3 are supplied to the burner 4, combusts the coal A. Heat generated by the coal A combustion reaction heats water via a water-cooling wall that is not shown, a heat transfer tube, superheaters 5, the economizer 6, and other heat recovery/heat transfer tubes to produce steam, which allows a turbine generator that is not shown to produce electric power.

The flue gas produced when the coal combustion boiler 1 combusts the coal A is exhausted via the flue gas outlet 7, which is located on the side facing the outlet of the economizer 6. At this point, the flue gas contains a large amount of ash having diameters ranging from 100 to 300 μm because the coal A is low-quality coal. The large-diameter (diameter ranging from 100 to 300 μm, for example) ash particles in the flue gas are collected, when they flow through the horizontal duct 8, in a bottom wall portion of the horizontal duct 8. The large-diameter ash particles collected in the bottom wall portion of the horizontal duct 8 then collide with the collision plate 16, which is disposed below the vertical duct 9, and fall into the hoppers 15. Since the partition plate 17 is disposed in each of the hoppers 15, the collected large-diameter ash particles do not scatter again but are held in the hoppers 15.

Ammonia is supplied through the ammonia supply nozzle 10c, which is disposed in the vertical duct 9, into the flue gas from which most of the large-diameter ash particles have been removed as described above, and the resultant flue gas is guided to the denitration catalyst 10b. NOx in the flue gas, when the flue gas passes through the denitration catalyst 10b, are reduced into nitrogen and water. Since most of the ash particles larger than or equal to 100 μm has been removed from the flue gas passing through the denitration catalyst 10b, the denitration catalyst 10b hardly wears. The flue gas then passes through the air heater 11, where the flue gas undergoes heat exchange with combustion air and is therefore cooled. After the ash particles are removed by the dust collector 12, and sulfur oxides are removed by the desulfurization device 13, the resultant flue gas is discharged via the chimney 14 into the air.

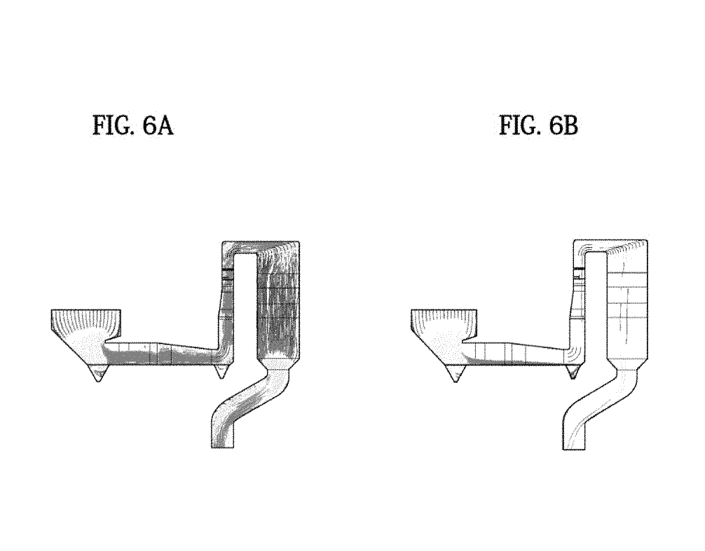

The large-diameter ash particle removal effect in the first embodiment will now be described in detail with reference to FIGS. 6 to 9. First, in the process of attaining the present invention, findings obtained by numerical analysis will be described. FIG. 6 shows results of analysis of the path of the ash particles from the flue gas outlet 7 to the denitration catalyst 10b. In the numerical analysis, the flow of the flue gas and the path of the ash particles were determined on the assumption that no collision plate 16 or partition plate 17 in the first embodiment is provided and the ash particles uniformly scatter in the outlet plane of the economizer 6 of the coal combustion boiler 1. FIG. 6(a) shows the path in a case where the ash particles has a diameter of 30 μm, and FIG. 6(b) shows the path in a case where the diameter is 200 μm. These figures show that the ash particles having the diameter of 30 μm roughly uniformly disperse in the ducts and reach the denitration catalyst 10b. In contrast, FIG. 6(b) shows that the ash particles having the diameter of 200 μm are locally present in a lower portion of the horizontal duct 8 at the inlet of the vertical duct 9. In consideration of the results described above, in the first embodiment, the hoppers 15 are disposed below the vertical duct 9, and the collision plate 16 is disposed above the hoppers 15, so that the ash particles that are locally present in the lower portion of the horizontal duct 8 and scatter are selectively guided to and collected by the hoppers 15.

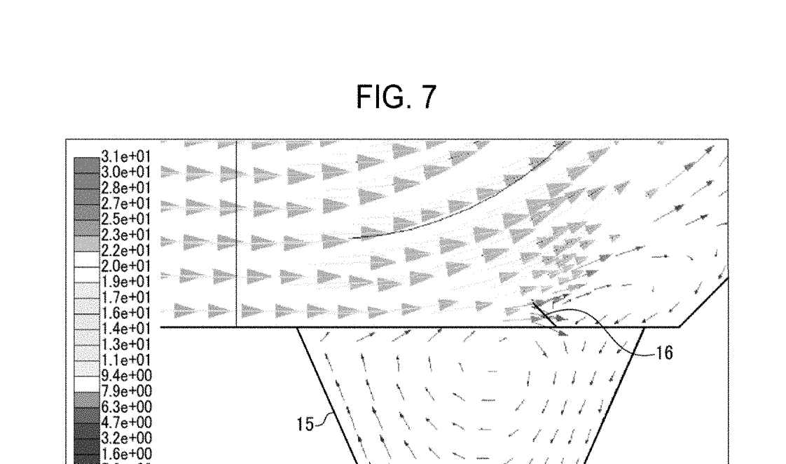

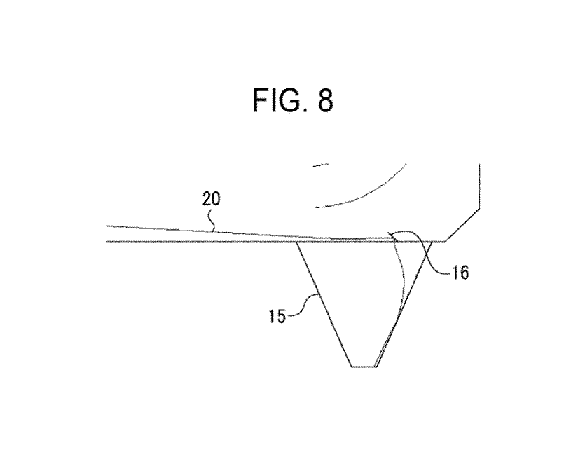

FIG. 8 shows a result of the numerical analysis in the case where the collision plate 16 is disposed above the hoppers 15. FIG. 8 shows that the ash particles locally present in the lower portion of the horizontal duct 8 collide with the collision plate 16, as indicated by the path 20, and are collected by the hoppers 15. FIG. 7 shows a result of calculation of the flow rate distribution in this case. The flue gas flow rate in the hoppers 15 is lowered to several meters/second or lower, whereby the proportion of the re-scattering ash particles in the hoppers 15 can be lowered.

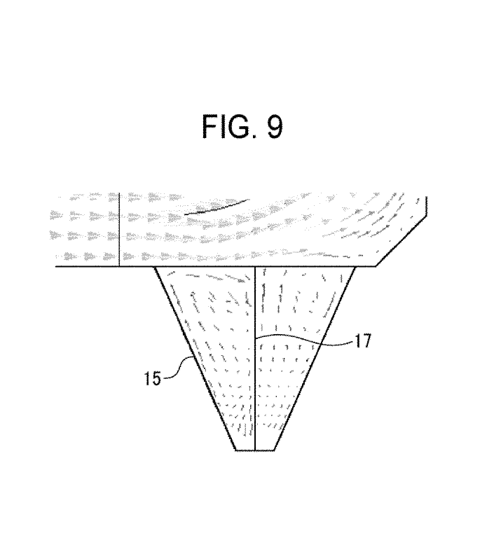

Further, FIG. 9 shows a result of the numerical analysis in the case where the partition plates 17 are disposed in the hoppers 15. Disposing the partition plates 17 in the hoppers 15 can suppress the flue gas flow in the hoppers 15 and therefore greatly reduce the amount of re-scattering ash collected in the hoppers 15.

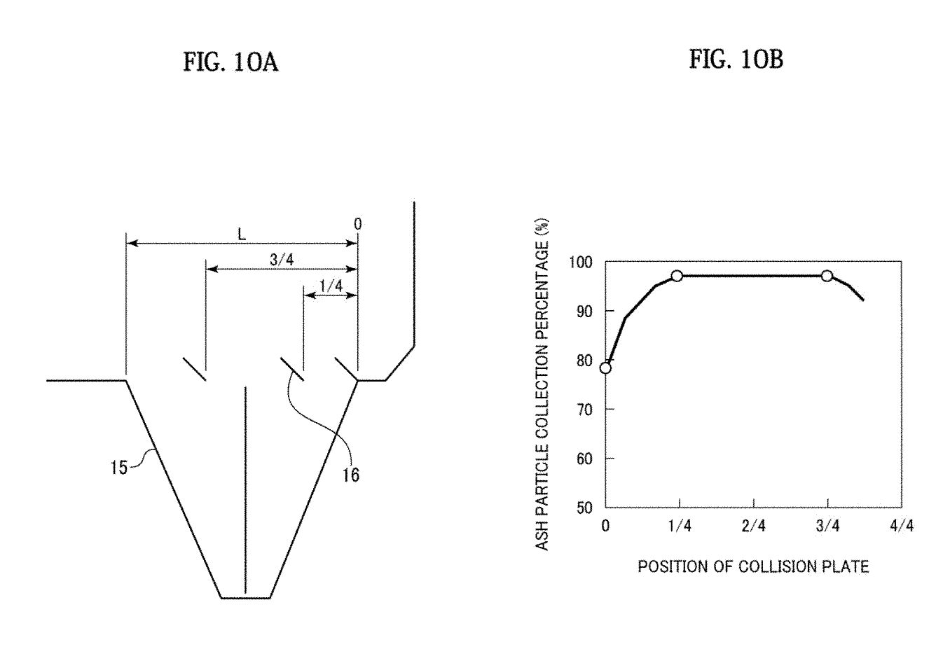

FIG. 10 shows a result of examination of an optimum position where the collision plate 16 is disposed. Results of evaluation of a soot collection percentage with the position of the collision plate 16 changed as shown in FIG. 10(a) are shown in FIG. 10(b). The position of the collision plate 16 is set with respect to a base point 0 at the far-side end of the upper-end openings of the hoppers 15 viewed from the side facing the horizontal duct 8, and the position is set at the base point 0 and points shifted toward the horizontal duct 8 and corresponding to one-fourth to three-fourths of the length L of the upper-end openings of the hoppers. As a result, FIG. 10(b) shows that the collection percentage decreases when the collision plate 16 is disposed at the base point 0. The results shown in FIG. 10(b) indicate that the collision plate 16 is effectively located in a position shifted from the base point 0 by one-fourth to three-fourths of the length L shown in FIG. 10(a). Further, in consideration of the influence on the flue gas flow, it is believed that the optimum position of the collision plate 16 is the position which is shifted from the base point 0 by one-fourth the length L and where the collision plate 16 does not block the flue gas flow.

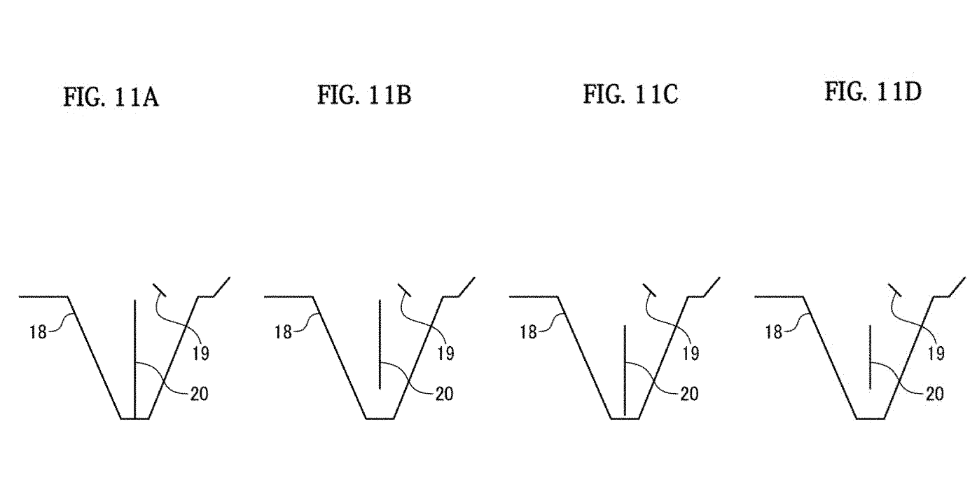

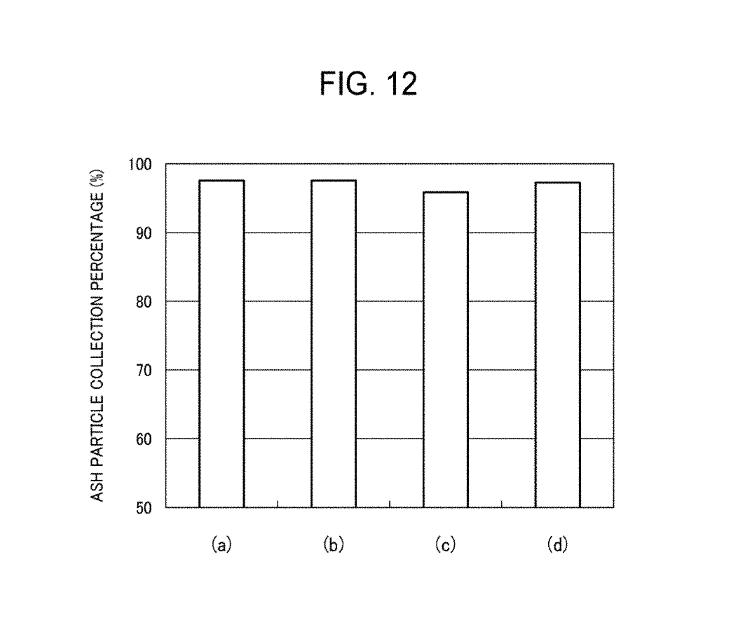

FIGS. 11 and 12 show results of examination of the shape of the re-scatter preventing partition plates 17. The partition plates 17 are provided in a position shifted from the base point 0 of the hoppers 15, which has been described above, by about half the length L of the upper-end openings of the hoppers, as in the case of the collision plate 16, in such a way that the partition plates 17 extend vertically downward, as shown in FIGS. 11(a) to 11(d). FIG. 11(a) shows a case where the partition plates 17 are disposed along the entire height of the hoppers 15. FIG. 11(b) shows a case where a one-fourth lower portion of each of the partition plates 17 is cut off. FIG. 11(c) shows a case where a one-fourth upper portion of each of the partition plates 17 is cut off. FIG. 11(d) shows a case where one-fourth upper and lower portions of each of the partition plates 17 are cut off. As a result, FIG. 12 shows that the differences in the shape do not greatly affect the re-scatter prevention effect, and that the vertical length of the partition plates 17 does not greatly affect the re-scatter prevention effect.

As described above, according to the first embodiment, nearly the entire ash particles having diameters of at least 100 μm can be collected in the hoppers 15 before the ash particles reach the denitration catalyst 10b. As a result, the amount of large-diameter ash particles that reach the denitration catalyst 10b can be greatly reduced, whereby the amount of wear of the denitration catalyst 10b can be suppressed.

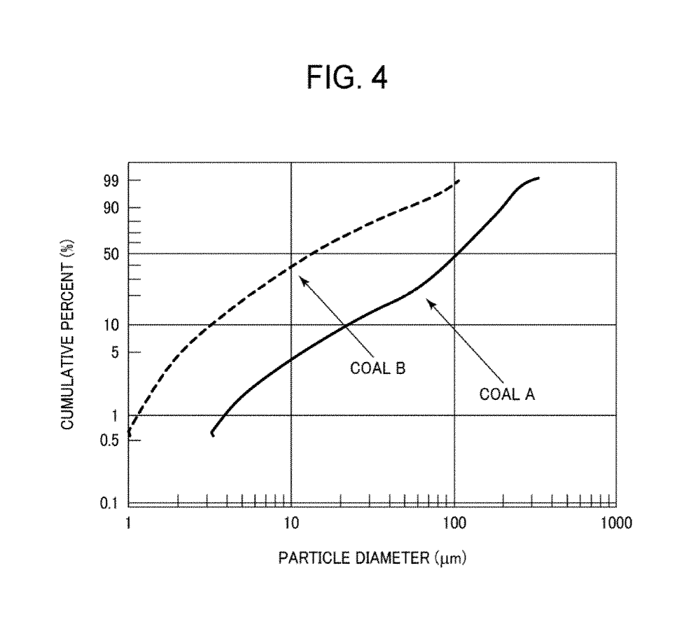

That is, the coal A is, for example, coal produced in an Inner Mongolia district of China, and the coal B is coal produced in Australia, as shown in FIGS. 4 and 5. The technical analysis values in FIG. 5 and the measured results of the distribution of the particle diameter of the ash particles contained in the flue gas show that the proportion of ash in the coal A is as high as 47%. Further the ash particle diameter distribution shown in FIG. 4 shows that 99% the coal-B particles have diameters smaller than or equal to 100 μm, whereas only about 50% the coal-A particles have diameters smaller than or equal to 100 μm, which means that half the coal-A ash particles is formed of ash particles greater than or equal to 100 μm.

In the case where the flue gas contains ash that accounts for 30-40% or higher, as in the case of fuel formed of the coal A or in the case where the flue gas contains ash particles having large diameters greater than or equal to 100 μm, the denitration catalyst undesirably wears in a short period. For example, the wire-cloth screen proposed in Patent Literature 1 and provided to remove ash mases having sizes ranging from about 5 to 10 mm can remove ash masses having sizes ranging from about 5 to 10 mm, which are larger than the openings of the catalyst layer, but cannot remove ash masses having sizes ranging from 100 μm to 5 mm, which are smaller than the sizes described above. Conversely, when the size of the openings of the wire-cloth screen is set, for example, at 100 μm, not only does pressure loss in the duct undesirably increase, but the frequency of occurrence of screen clogging undesirably increases. Further, since ash particles having diameters ranging from 100 to 300 μm accompany flue gas flowing at a flow rate of several meters/second, the louver formed of a plurality of plate-shaped members disposed in the inner wall of the duct still results in wear of the denitration catalyst because the ash having collided with the louver accompanies the flue gas flow again and is blown toward the downstream side. The first embodiment of the present invention can solve the problem with the related art and prevent, with a simple configuration, wear and damage of the denitration catalyst due to the flue gas containing ash particles greater than or equal to 100 μm even when coal containing ash particles greater than or equal to 100 μm is used.

### Variation of First Embodiment

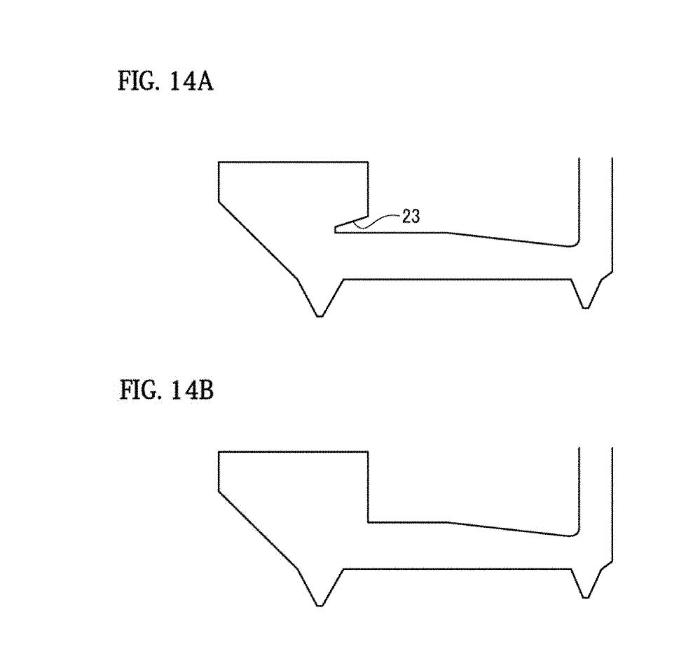

In the case where the flue gas outlet 7, to which the horizontal duct 8 is connected, is formed below the sidewall of the economizer 6, an overhang section 23, which overhangs from the sidewall above the opening of the flue gas outlet 7, can be provided in the flue gas channel, in addition to the first embodiment, as shown in FIG. 14(a). That is, the flue gas outlet 7, to which the horizontal duct 8 is connected, is formed in the sidewall of the downward flue gas channel in which the economizer 6, which is one of the heat recovery/heat transfer tubes of the coal combustion boiler 1, is disposed. In particular, the overhang section 23 is provided in the flue gas channel so as to overhang from the sidewall of the flue gas channel above the horizontal duct at the flue gas outlet 7. FIG. 14(b) corresponds to the first embodiment, in which no overhang section 23 is provided.

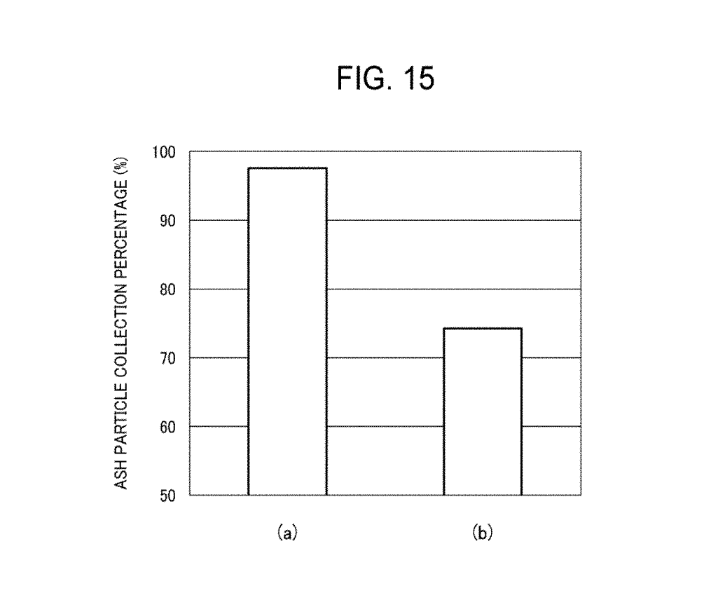

According to the present variation, providing the overhang section 23 greatly improves an ash particle collection percentage A, as compared with an ash particle collection percentage B in the case where no overhang section 23 is provided, as shown in FIG. 15. A conceivable reason for this is that providing the overhang section 23 enhances the effect of collecting the ash particles in a lower portion of the horizontal duct for improvement in the percentage of collection of the ash particle in the hoppers 15. The greater the amount of overhang of the overhang section 23, the greater the expected ash particle separation effect, but the amount of overhang is desirably set at about one-fourth the channel width at the maximum in consideration of an increase in power required to drive a fan according to an increase in the pressure loss.

### Second Embodiment

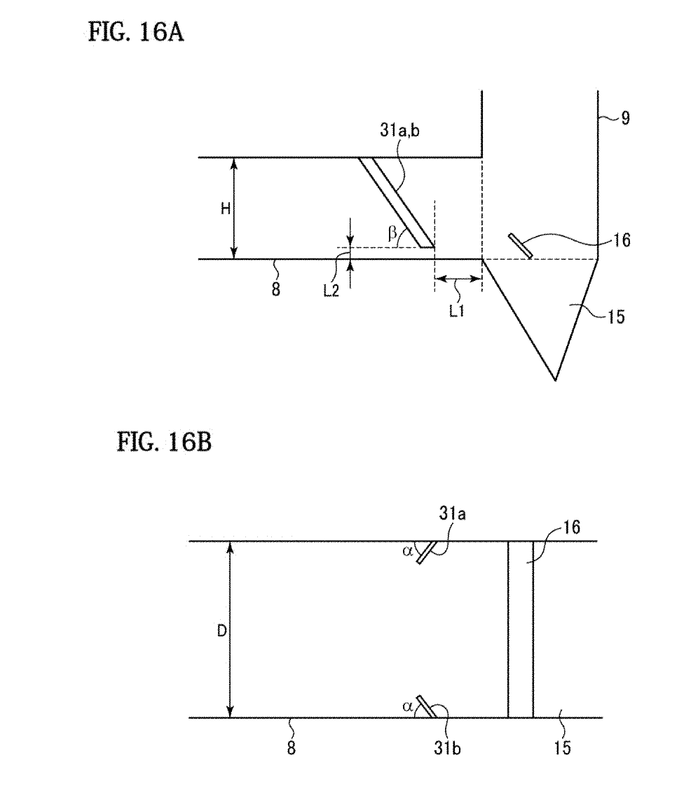

FIG. 16 is a configuration diagram of key parts in a second embodiment of the flue gas treatment apparatus according to the present invention. The second embodiment differs from the first embodiment in that a sidewall collision plate is provided in the horizontal duct 8, and the other points are the same as those in the first embodiment. The same constituent parts therefore have the same reference characters and will not be described.

FIG. 16(a) is a see-through side view of the interior of the horizontal duct 8 and one of the hoppers 15, and FIG. 16(b) is a see-through plan view showing the interior of the horizontal duct 8 and the hopper 15. A pair of sidewall collision plates 31a and 31b are symmetrically provided on sidewalls of the horizontal duct 8 that face each other, as shown in FIG. 16(b). The pair of sidewall collision plates 31a and 31b are provided so as to incline by an angle α with respect to the upstream sidewalls of the horizontal duct 8, as shown in FIG. 16(b). The sidewall collision plates 31a and 31b are further provided so as to incline by an angle β with respect to the upstream bottom wall of the horizontal duct 8, as shown in FIG. 16(a). Further, the positions of the lower ends of the sidewall collision plates 31a and 31b are so set as to be separate from the position where the horizontal duct 8 is connected to the hopper 15 toward the upstream side by a distance L1 and further separate from the bottom wall of the horizontal duct 8 by a distance L2. The width d of the sidewall collision plates 31a and 31b is set at a value selected from values ranging from 2 to 7% of the lateral width D of the horizontal duct 18.

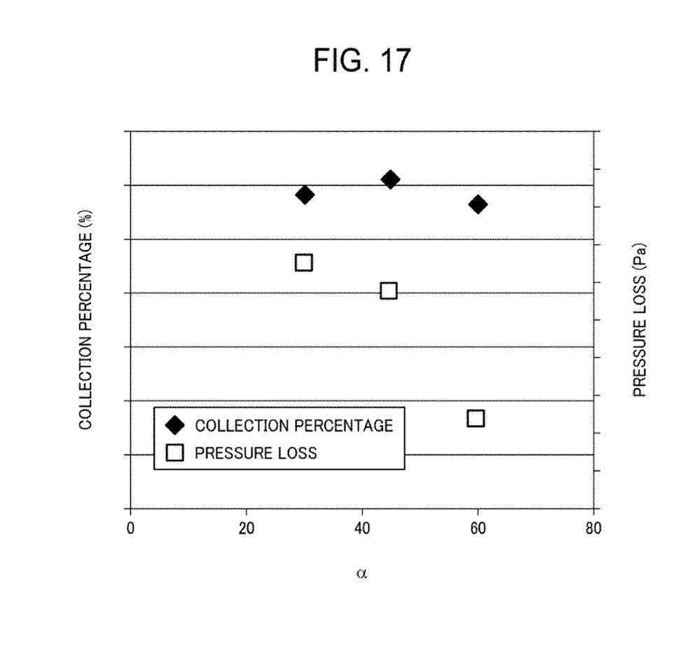

The inclination angles α and β and the width d of the sidewall collision plates 31a and 31b and the distance L1 thereto are determined on the basis of calculated ash particle collection percentages shown in FIGS. 17 to 20. That is, FIG. 17 shows the relationship between the angle α and the ash particle collection percentage. Increasing the angle α lowers the loss of the pressure of the flue gas flow due to the pair of sidewall collision plates 31a and 31b, as shown in FIG. 17. A conceivable reason for this is that the area of the region where the flue gas flow separates decreases as the angle α increases. However, since the ash particle collection percentage follows an upwardly convex shape in the range from α=30° to 60° with the ash particle collection percentage maximized at 45°, it is believed that α is most preferably set at 45°. Further, the ash particle collection percentage decreases in the range beyond α=45°. In consideration of the facts described above, although the angle α can be any of the values from 30° to 60°, the angle α is preferably selected from values from 30° to 45°.

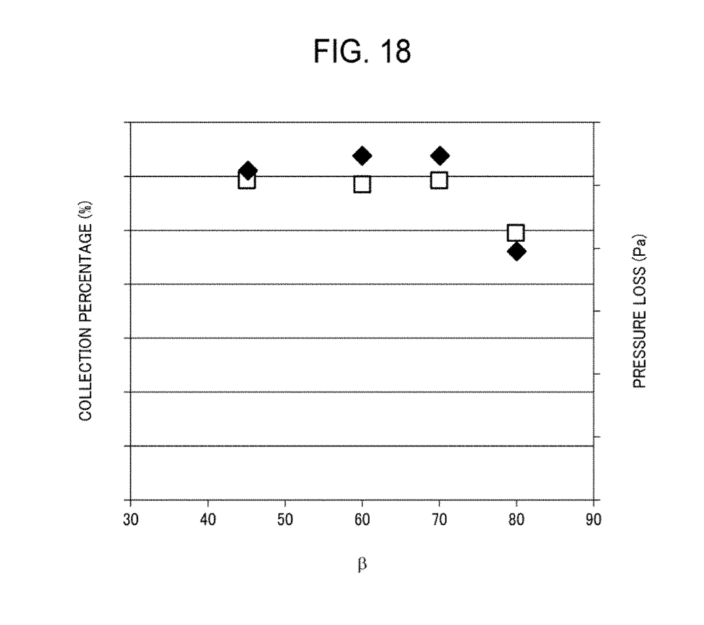

On the other hand, angles β smaller than 45° are undesirable because the horizontal length of the sidewall collision plates increases. Conversely, angles β greater than 45° slightly increase the ash particle collection percentage, but the amount of increase is small, as shown in FIG. 18. However, when the angle β is set at 80°, the pressure loss sharply decreases, and the ash particle collection percentage also tends to decrease accordingly. In consideration of the facts described above, the angle β is selected from values ranging from 45° to 70°, preferably from 60 to 70°.

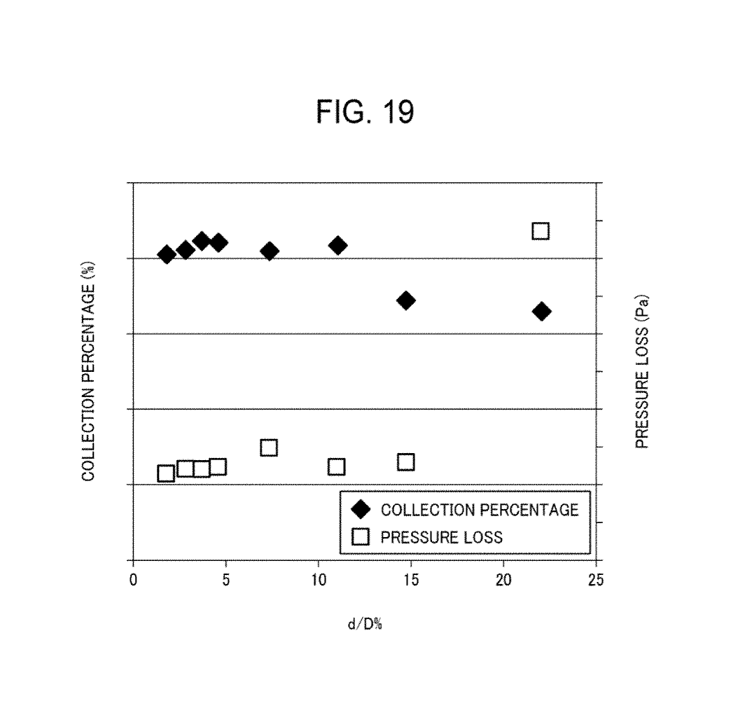

The width d of the sidewall collision plates 31a and 31b does not greatly improve the ash particle collection percentage in the region where d/D ranges from 7 to 20% but increases the pressure loss, as shown in FIG. 19. In consideration of the facts described above, the width d is preferably selected from values ranging from 2 to 7% of the horizontal duct width D.

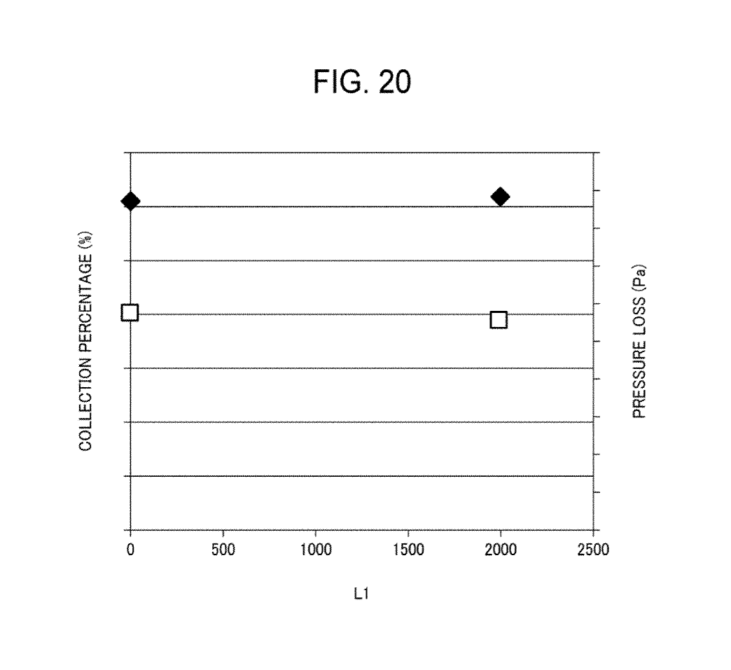

Further, the distance L1 between the lower ends of the sidewall collision plates 31a, 31b and the position where the horizontal duct 8 is connected to the hopper 15 does not affect the ash particle collection percentage, specifically, even when the distance L1 increases, as shown in FIG. 20. Further, an increase in the distance L1 merely slightly lowers the pressure loss. The lower ends of the sidewall collision plates 31a and 31b may therefore be located in the position of the upper-end opening of the hopper 15, that is, the position corresponding to L1=0.

The distance L2, by which the lower ends of the sidewall collision plates 31a and 31b are separate from the bottom wall of the horizontal duct 8, is determined in consideration of the fact that the ash particles collected by the sidewall collision plates 31a and 31b fall onto the bottom wall of the horizontal duct 8. No problem occurs even when the distance L2 is set at zero because most of the falling ash particles are eventually recovered in the hoppers 15.

According to the thus configured second embodiment, in the case where the large-diameter ash particles accompany the flue gas flow not only along the bottom wall of the horizontal duct 8 but the sidewalls thereof, the pair of sidewall collision plates 31a and 31b can further improve the ash particle collection percentage as compared with the first embodiment. In particular, since the sidewall collision plates 31a and 31b allow collection of the large-diameter ash particles without a large increase in the pressure loss, the combination of the second embodiment with the first embodiment can effectively improve the large-diameter ash particle collection percentage.

### Third Embodiment

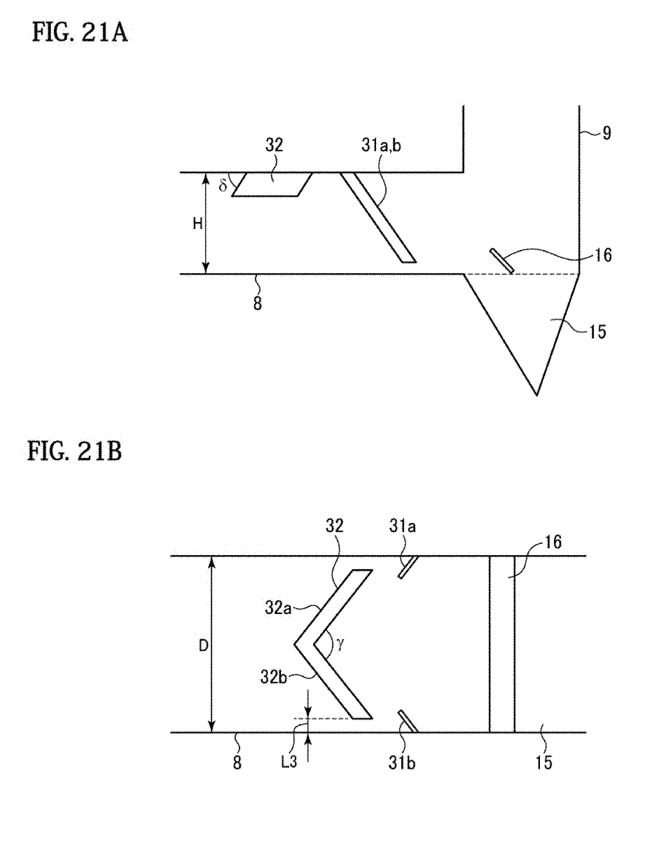

FIG. 21 shows a configuration diagram of key parts in a third embodiment of the flue gas treatment apparatus according to the present invention. The third embodiment differs from the first and second embodiments in that the ceiling wall of the horizontal duct 8 is provided with a ceiling collision plate that vertically extends from the ceiling wall. The other points are the same as those in the first and second embodiments, and the same constituent parts therefore have the same reference characters and will not be described.

FIG. 21(a) is a see-through side view of the interior of the horizontal duct 8 and one of the hoppers 15, and FIG. 21(b) is a see-through plan view showing the interior of the horizontal duct 8 and the hopper 15. A ceiling collision plate 32 is provided so as to vertically extend from the ceiling wall of the horizontal duct 8, as shown in FIGS. 21(a) and 21(b). The ceiling collision plate 32 is provided so as to be located in a position upstream of the pair of sidewall collision plates 31a and 31b. The ceiling collision plate 32 is formed of a pair of plate pieces 32a and 32b, which extend from a widthwise central portion of the ceiling wall toward the sidewalls on opposite sides, and the angle γ between the pair of plate pieces is set at a value ranging from 45 to 70°, preferably from 60 to 70°. Further, the surfaces of the pair of plate pieces 32a and 32b incline toward the upstream side of the horizontal duct 8 by an angle δ ranging from 30 to 60°, preferably from 45 to 60° with respect to the ceiling wall. Moreover, the pair of plate pieces 32a and 32b of the ceiling collision plate 32 are provided such that end portions thereof on the sides facing the opposite sidewalls are separate from the corresponding sidewalls at least by the width (height) of the sidewall collision plates.

The third embodiment is preferable in a case where a coal combustion boiler 1 having a rotary combustion furnace. That is, in a rotary combustion furnace, in which large-diameter ash particles scatter toward the ceiling wall of the horizontal duct 8 in some cases, the ash particles are caused to collide with the ceiling collision plate 32 and collected. The situation in which the ash particles greater than or equal to 100 μm reach the denitration catalyst 10b can therefore avoided, whereby the amount of wear of the catalyst can be greatly reduced.

A distance L3 by which the pair of plate pieces 32a and 32b of the ceiling collision plate 32 are separate from the corresponding sidewalls is at least the width d of the sidewall collision plates 31a and 31b, or the pair of plate pieces 32a and 32b are provided so as to be separate by a distance smaller than L3=d tan α. That is, the distance L3 is preferably smaller than the width relating to the sidewall collision plates 31a and 31b (=d tan α).

According to the third embodiment in combination with the first or second embodiment, the large-diameter ash particle collection percentage can be effectively improved by using the third embodiment even when a coal combustion boiler 1 having a rotary combustion furnace is used.

The present invention has been described above on the basis of the embodiments, but the present invention is not limited thereto. It is apparent for a person skilled in the art that the present invention can be implemented in a form modified or changed to the extent that the modification or change falls within the scope of the substance of the present invention, and the thus modified or changed form, of course, belongs to the claims of the present application.

### REFERENCE SIGNS LIST

1 Coal combustion boiler
7 Flue gas outlet
8 Horizontal duct
9 Vertical duct
10 Denitration apparatus
10b Denitration catalyst
10c Ammonia supply nozzle
15 Hopper
16 Collision plate
17 Partition plate

1-13. (canceled)

14. A flue gas treatment apparatus comprising:
a denitration apparatus having a denitration catalyst that reduces nitrogen oxides in flue gas exhausted from a coal combustion boiler; and
a duct that guides the flue gas from the coal combustion boiler to the denitration apparatus, the duct being formed of a horizontal duct connected to a flue gas outlet of the boiler, a vertical duct connected to the horizontal duct, and a hopper provided below a connecting portion where the horizontal duct and the vertical duct are connected to each other, wherein
a collision plate that causes ash particles in the flue gas to collide with the collision plate and fall into the hopper is provided in an upper-end opening section of the hopper, and
the collision plate is provided so as to incline toward the horizontal duct by a set angle “a” (0°<a<90°) with respect to an upper-end opening plane of the hopper.

15. The flue gas treatment apparatus according to claim 14, wherein
the collision plate is formed in a rectangular shape and disposed such that a lower long edge of the collision plate is located in the upper-end opening plane of the hopper corresponding to an extension plane of a bottom wall of the horizontal duct and the lower long edge extends in a width direction of the horizontal duct.

16. The flue gas treatment apparatus according to claim 14, wherein
the collision plate is provided in a range that is measured from a far-side end of the upper-end opening of the hopper viewed from a side facing the horizontal duct and corresponds to one-fourth to three-fourths of a length of the upper-end opening.

17. The flue gas treatment apparatus according to claim 15, wherein
the collision plate is provided in a range that is measured from a far-side and of the upper-end opening of the hopper viewed from a side facing the horizontal duct and corresponds to one-fourth to three-fourths of a length of the upper-end opening.

18. The flue gas treatment apparatus according to claim 14, wherein
a partition plate is further provided in the hopper so a to be perpendicular to an extension of the horizontal duct and to extend downward in a vertical direction.

19. The flue gas treatment apparatus according to claim 18, wherein
the partition plate is provided in a position that is measured from a far-side end of the upper-end opening of the hopper viewed from a side facing the horizontal duct and corresponds to half a length of the upper-end opening.

20. The flue gas treatment apparatus according to claim 14, wherein
the flue gas outlet is formed in a sidewall of a downward flue gas channel in which a heat recovery/heat transfer tube of the coal combustion boiler is disposed, and an overhang section is provided in the flue gas channel so as to overhang from the sidewall of the flue gas channel above the horizontal duct at the flue gas outlet.

21. The flue gas treatment apparatus according to claim 20, wherein
the horizontal duct is provided with a pair of sidewall collision plates that are located in a position separate from the hopper and upstream thereof and extend from an upper end to a lower end of a pair of sidewalls facing each other.

22. The flue gas treatment apparatus according to claim 21, wherein
the sidewall collision plats are provided so as to incline by an angle ranging from 30° to 60°, preferably from 30° to 45° with respect to upstream sidewalls of the horizontal duct and further incline by an angle ranging from 45 to 70°, preferably from 60 to 70° with respect to an upstream bottom wall of the horizontal duct.

23. The flue gas treatment apparatus according to claim 22, wherein
the sidewall collision plates each have a width set at a value ranging from 2 to 7% of a lateral width of the horizontal duct, and the sidewall collision plates are provided such that lower ends thereof are separate from the bottom wall of the horizontal duct.

24. The flue gas treatment apparatus according to claim 21, wherein
a ceiling collision plate is provided in the horizontal duct so as to vertically extend from a ceiling wall thereof upstream of the pair of sidewall collision plates, and the ceiling collision plate is formed of a pair of plate pieces that extend from a widthwise central portion of the ceiling wall toward sidewalls on opposite sides, with an angle between the pair of plate pieces set at a value ranging from 45 to 70°, preferably from 60 to 70° and surfaces of the pair of plate pieces inclining toward the upstream side of the horizontal duct by an angle ranging from 30° to 60°, preferably from 45° to 60° with respect to the ceiling wall.

25. The flue gas treatment apparatus according to claim 24, wherein
the ceiling collision plate is provided such that end portions thereof facing the opposite sidewalls are separate from the corresponding sidewalls at least by a height of the sidewall collision plates.
